(19) United States
(12) Patent Application Publication
(10) Pub. No.: US 2024/0372242 A1
(43) Pub. Date: Nov. 7, 2024

(54) TRANSMISSION LINE, PROCESSING DEVICE, AND QUANTUM COMPUTER

(71) Applicant: KABUSHIKI KAISHA TOSHIBA, Tokyo (JP)

(72) Inventor: Tamio KAWAGUCHI, Kawasaki Kanagawa (JP)

(73) Assignee: KABUSHIKI KAISHA TOSHIBA, Tokyo (JP)

(21) Appl. No.: 18/432,621

(22) Filed: Feb. 5, 2024

(30) Foreign Application Priority Data
May 1, 2023 (JP) 2023-075481

(51) Int. Cl. H01P 3/00

(52) U.S. Cl. CPC H01P 3/003

(57) ABSTRACT

According to one embodiment, a transmission line includes a first structure, a second structure, and a first intermediate conductive layer. The first structure includes a first conductive layer, a first opposing conductive layer, and a first conductive line. The first conductive line extends along a first direction. The first direction crosses a second direction from the first conductive layer to the first opposing conductive layer. The second structure includes a second conductive layer, a second opposing conductive layer, and a second conductive line. The second conductive line extends along the first direction. The first intermediate conductive layer includes a first line extending along the first direction and a second line extending along the first direction. A third direction from the first line to the second line crosses a plane including the first direction and the second direction.

### CROSS-REFERENCE TO RELATED APPLICATIONS

This application is based upon and claims the benefit of priority from Japanese Patent Application No. 2023-075481, filed on May 1, 2023; the entire contents of which are incorporated herein by reference.

### FIELD

Embodiments described herein relate generally to a transmission line, a processing device, and a quantum computer.

### BACKGROUND

For example, in a processing device such as a quantum computer, a plurality of circuits are coupled by a transmission line. For example, if the isolation characteristics between multiple wiring lines are poor, performance will deteriorate. It is desired to improve the characteristics of the transmission line.

### BRIEF DESCRIPTION OF THE DRAWINGS

FIGS. 1A to 1G are schematic plan views illustrating a transmission line according to a first embodiment;

FIGS. 2A to 2C are schematic cross-sectional views illustrating the transmission line according to the first embodiment;

FIG. 3A to 3G are schematic plan views illustrating a transmission line according to the first embodiment;

FIGS. 4A to 4C are schematic cross-sectional views illustrating the transmission line according to the first embodiment;

FIGS. 5A to 5G are schematic plan views illustrating a transmission line according to the first embodiment;

FIGS. 6A to 6C are schematic cross-sectional views illustrating the transmission line according to the first embodiment;

FIG. 7 is a graph illustrating characteristics of a transmission line;

FIG. 8 is a schematic plan view illustrating a part of a transmission line according to the first embodiment;

FIG. 9 is a schematic plan view illustrating a part of a transmission line according to the first embodiment;

FIG. 10 is a schematic cross-sectional view illustrating a transmission line according to the first embodiment; and

FIG. 11 is a schematic diagram illustrating a processing device according to a second embodiment.

### DETAILED DESCRIPTION

According to one embodiment, a transmission line includes a first structure, a second structure, and a first intermediate conductive layer. The first structure includes a first conductive layer, a first opposing conductive layer, and a first conductive line. The first conductive line is provided between the first conductive layer and the first opposing conductive layer. The first conductive line extends along a first direction. The first direction crosses a second direction from the first conductive layer to the first opposing conductive layer. The second structure includes a second conductive layer, a second opposing conductive layer, and a second conductive line. The first opposing conductive layer is provided between the first opposing conductive layer and the second opposing conductive layer. The second conductive layer is provided between the first opposing conductive layer and the second opposing conductive layer. The second conductive line is provided between the second conductive layer and the second opposing conductive layer. The second conductive line extends along the first direction. The first intermediate conductive layer is provided between the first opposing conductive layer and the second conductive layer. The first intermediate conductive layer includes a first line extending along the first direction and a second line extending along the first direction. A third direction from the first line to the second line crosses a plane including the first direction and the second direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

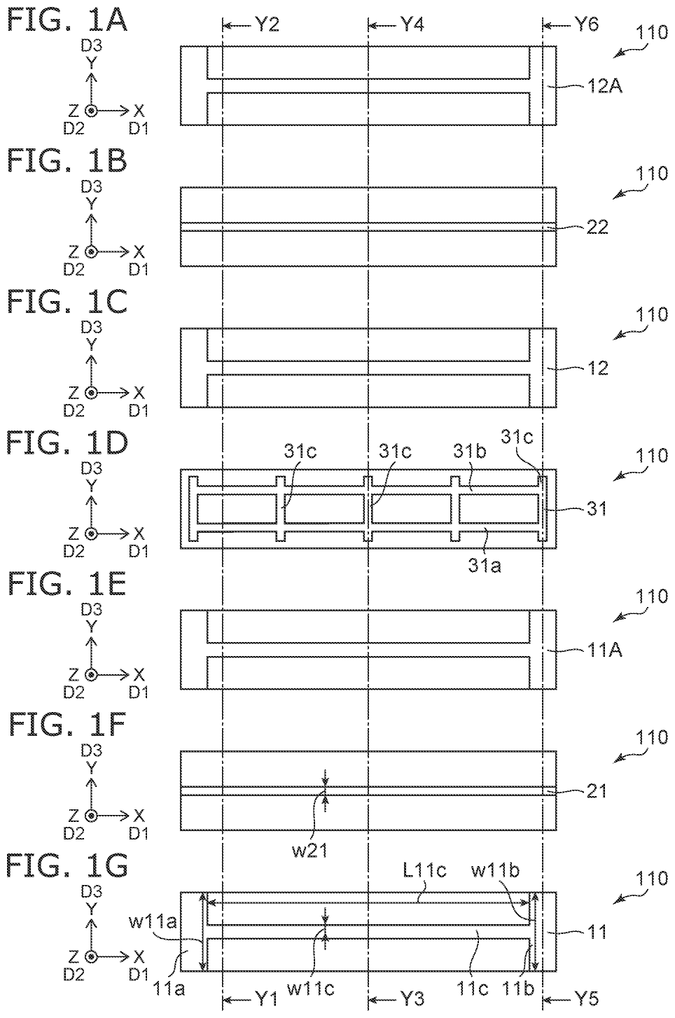

FIGS. 1A to 1G are schematic plan views illustrating a transmission line according to a first embodiment.

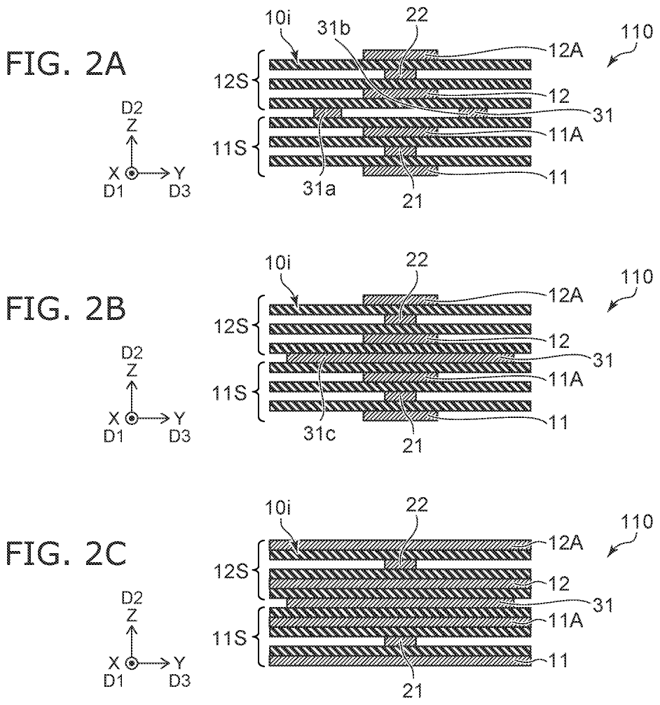

FIGS. 2A to 2C are schematic cross-sectional views illustrating the transmission line according to the first embodiment.

FIG. 2A is a cross-sectional view taken along the line Y1-Y2 in FIGS. 1A to 1G. FIG. 2B is a sectional view taken along the line Y3-Y4 of FIGS. 1A to 1G. FIG. 2C is a sectional view taken along the line Y5-Y6 of FIGS. 1A to 1G.

As shown in FIGS. 2A and 2B, a transmission line 110 according to the embodiment includes a first structure 11S, a second structure 12S, and a first intermediate conductive layer 31. The first structure 11S includes a first conductive layer 11, a first opposing conductive layer 11A, and a first conductive line 21. The second structure 12S includes a second conductive layer 12, a second opposing conductive layer 12A, and a second conductive line 22.

FIG. 1A illustrates the second opposing conductive layer 12A. FIG. 1B illustrates the second conductive line 22. FIG. 1C illustrates the second conductive layer 12. FIG. 1D illustrates the first intermediate conductive layer 31. FIG. 1E illustrates the first opposing conductive layer 11A. FIG. 1F illustrates the first conductive line 21. FIG. 1G illustrates the first conductive layer 11.

As shown in FIGS. 2A to 2C, the first conductive line 21 is provided between the first conductive layer 11 and the first opposing conductive layer 11A. The first conductive line 21 extends along a first direction D1.

The first direction D1 crosses a second direction D2 from the first conductive layer 11 to the first opposing conductive layer 11A. The second direction D2 is defines as a Z-axis direction. One direction perpendicular to the Z-axis direction is defined as an X-axis direction. A direction perpendicular to the Z-axis direction and the X-axis direction is defined as a Y-axis direction.

The first opposing conductive layer 11A is provided between the first conductive layer 11 and the second opposing conductive layer 12A. The second conductive layer 12 is provided between the first opposing conductive layer 11A and the second opposing conductive layer 12A.

The second conductive line 22 is provided between the second conductive layer 12 and the second opposing conductive layer 12A. The second conductive line 22 extends along the first direction D1.

The first intermediate conductive layer 31 is provided between the first opposing conductive layer 11A and the second conductive layer 12. The first intermediate conductive layer 31 includes a first line 31a extending along the first direction D1 and a second line 31b extending along the first direction D1. A third direction D3 from the first line 31a to the second line 31b crosses a plane including the first direction D1 and the second direction D2. The third direction D3 may be, for example, the Y-axis direction.

Signals pass through the first conductive line 21. The first conductive layer 11 and the first opposing conductive layer 11A may function as an electromagnetic shield, for example. Signals pass through the second conductive line 22. The second conductive layer 12 and the second opposing conductive layer 12A may function as an electromagnetic shield, for example.

In the embodiment, the first structure 11S functions as one transmission line. The second structure 12S functions as another transmission line. Multiple transmission lines are stacked. In such a configuration, a plurality of transmission lines influence each other. For example, coupling may occur. In the embodiment, the first intermediate conductive layer 31 is provided between the first structure 11S and the second structure 12S. This effectively separates the first structure 11S and the second structure 12S. High isolation characteristics can be obtained. According to the embodiment, a transmission line with improved characteristics can be provided.

In the embodiment, the first intermediate conductive layer 31 includes a first line 31a and a second line 31b extending along the first direction D1. As shown in FIG. 2A, a position of the first conductive line 21 in the third direction D3 is between a position of the first line 31a in the third direction D3 and a position of the second line 31b in the third direction D3. A position of the second conductive line 22 in the third direction D3 is between the position of the first line 31a in the third direction D3 and the position of the second line 31b in the third direction D3 in the third direction D3.

For example, the first conductive line 21 and the second conductive line 22 through which the signal propagates are provided between the first line 31a and the second line 31b in the third direction D3. Thereby, electromagnetic induction between the first conductive line 21 and the second conductive line 22 is effectively suppressed by the first line 31a and the second line 31b. Examples of the characteristics of the transmission line will be described later.

As shown in FIG. 1D, the first intermediate conductive layer 31 may further include a connecting conductive layer 31c. The connecting conductive layer 31c connects a part of the first line 31a and a part of the second line 31b. The first line 31a and the second line 31b are electrically connected to each other by the connecting conductive layer 31c. For example, when non-uniform symmetry of the structure occurs due to manufacturing variations, a potential difference occurs between the first line 31a and the second line 31b. By providing the connecting conductive layer 31c, the potential difference is reduced, and unnecessary radiation is suppressed, resulting in higher isolation characteristics.

A plurality of connecting conductive layers 31c may be provided. The plurality of connecting conductive layers 31c are arranged along the first direction D1. For example, the plurality of connecting conductive layers 31c may be provided at one pitch.

As shown in FIGS. 1B and 1F, the pattern shape of the second conductive line 22 may be the same as the pattern shape of the first conductive line 21.

As shown in FIGS. 1A, 1C, 1E, and 1G, the pattern shapes of the first opposing conductive layer 11A, the second conductive layer 12, and the second opposing conductive layer 12A may be substantially the same as the pattern shape of the first conductive layer 11. These conductive layers act as grounds for the signal lines. These conductive layers may function as an electromagnetic shield that suppresses electromagnetic field radiation from the signal line.

As shown in FIG. 1G, the first conductive layer 11 may include a first portion 11a and a first opposing portion 11b. A direction from the first portion 11a to the first opposing portion 11b is along the first direction D1. The first portion 11a may be one end. The first opposing portion 11b may be another end. The first conductive layer 11 may further include a first intermediate portion 11c. The first intermediate portion 11c is provided between the first portion 11a and the first opposing portion 11b. The first intermediate portion 11c extends along the first direction D1.

As shown in FIG. 1G, a length w11c (width) of the first intermediate portion 11c along the third direction D3 is shorter than a length L11c of the first intermediate portion 11c along the first direction D1. Such a shape suppresses heat conduction between the first portion 11a and the first opposing portion 11b. For example, high heat insulation properties can be obtained. For example, when the transmission line 110 is applied to a quantum computer or the like, the influence of heat is suppressed, making it easier to obtain high characteristics.

In the embodiments, the temperature of the first portion 11a may be different from the temperature of the first opposing portion 11b. Even in such a case, the temperature difference between these portions can be easily maintained at the desired state due to the high heat insulation properties.

As shown in FIG. 1F, a length (width) of the first conductive line 21 along the third direction D3 is defined as a length w21. In the embodiment, the length w11c (width) of the first intermediate portion 11c is preferably greater than or equal to the length w21 (width) of the first conductive line 21. Higher isolation characteristics can be obtained. For example, the length w11c may be not less than 1 time and not mor than 3 times the length w21. If the length w11c is excessively long, for example, heat conduction will increase.

As shown in FIGS. 2A to 2C, the transmission line 110 may include an insulating member 10i. At least a part of the insulating member 10i is provided at at least one of the first position, the second position, the third position, and or fourth position. The first position is between the first conductive layer 11 and the first conductive line 21. The second position is between the first conductive line 21 and the first opposing conductive layer 11A. The third position is between the second conductive layer 12 and the second conductive line 22. The fourth position is between the second conductive line 22 and the second opposing conductive layer 12A.

The insulating member 10i may be, for example, a substrate. For example, gaps or the like may be provided between multiple portions of the insulating member 10i. It is easier to obtain higher insulation properties. The insulating member 10i may include at least one of an inorganic material or an organic material. The insulating member 10i may include at least one selected from the group consisting of polyimide, liquid crystal polymer, glass cloth, fluorine resin, and ceramic. Polyimide or liquid crystal polymers are used, for example, in flexible substrates. Ceramics include, for example, alumina. The insulating member 10i may include a substrate including the above-mentioned material.

In the embodiments, the conductive layer and conductive lines may include metal. The metal may include, for example, at least one selected from the group consisting of gold and copper. The conductive layers and the conductive lines may include at least one selected from the group consisting of aluminum, an alloy including aluminum, an alloy including niobium, an alloy including niobium titanium, and an alloy including tantalum.

In the embodiment, the first intermediate conductive layer 31 may be electrically connected to the first conductive layer 11, the first opposing conductive layer 11A, the second conductive layer 12, and the second opposing conductive layer 12A. The potentials of these conductive layers are fixed. The potentials of these conductive layers may be set to ground potential. Since no potential difference occurs, unnecessary radiation is suppressed and high isolation characteristics are obtained.

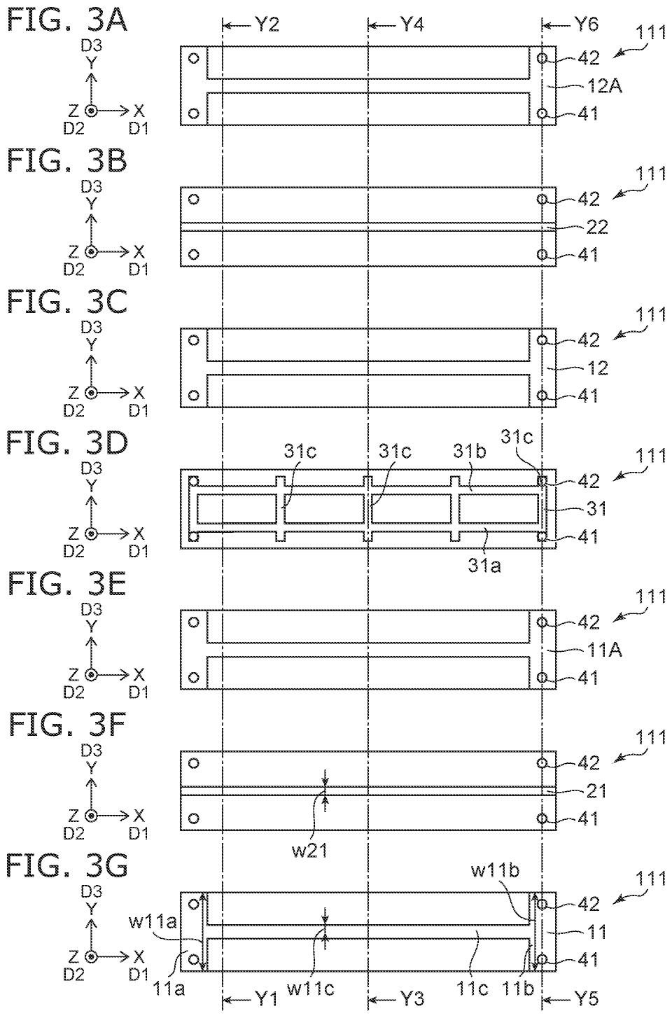

FIG. 3A to 3G are schematic plan views illustrating a transmission line according to the first embodiment.

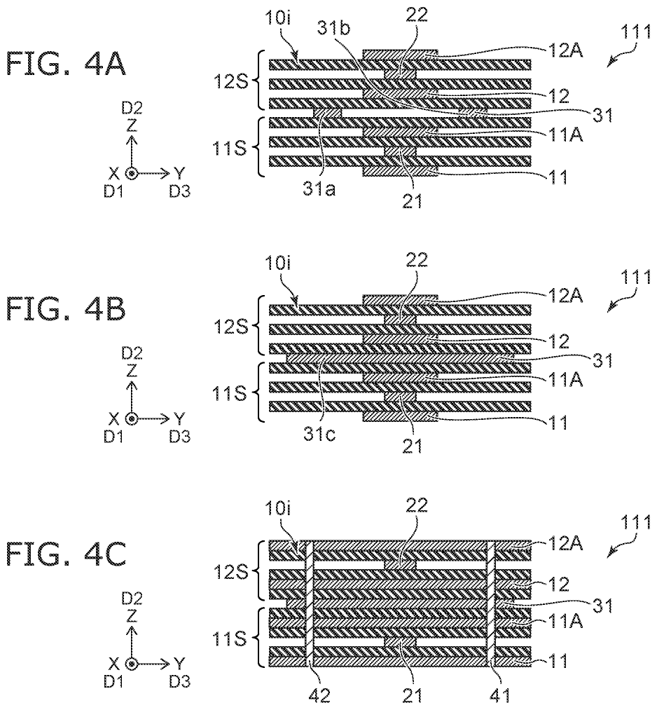

FIGS. 4A to 4C are schematic cross-sectional views illustrating the transmission line according to the first embodiment.

FIG. 4A is a cross-sectional view taken along the line Y1-Y2 in FIGS. 3A to 3G. FIG. 4B is a sectional view taken along the line Y3-Y4 in FIGS. 3A to 3G. FIG. 4C is a sectional view taken along the line Y5-Y6 of FIGS. 3A to 3G.

As shown in FIGS. 4A to 4C, the transmission line 111 according to the embodiment includes a first connecting member 41. The transmission line 111 may further include a second connecting member 42. The configuration of the transmission line 111 except for this may be the same as the configuration of the transmission line 110.

The first connecting member 41 extends along the second direction D2. The first connecting member 41 electrically connects the first opposing conductive layer 11A and the second conductive layer 12 to each other. The second connecting member 42 extends along the second direction D2. The second connecting member 42 electrically connects the first opposing conductive layer 11A and the second conductive layer 12 to each other. The first connecting member 41 and the second connecting member 42 may be electrically connected to the first conductive layer 11 and the second opposing conductive layer 12A. The first connecting member 41 and the second connecting member 42 may be electrically connected to the first intermediate conductive layer 31. These connecting members are, for example, via conductors. These connecting members electrically connect the stacked conductive layers to each other. A potential difference between these conductive layers becomes less likely to be generated.

A direction from the first connecting member 41 to the second connecting member 42 is, for example, along the third direction D3. A plurality of first connecting members 41 and a plurality of second connecting members 42 may be provided. A direction from one of the plurality of first connecting members 41 to another one of the plurality of first connecting members 41 is along the first direction D1. A direction from one of the plurality of second connecting members 42 to another one of the plurality of second connecting members 42 is along the first direction D1.

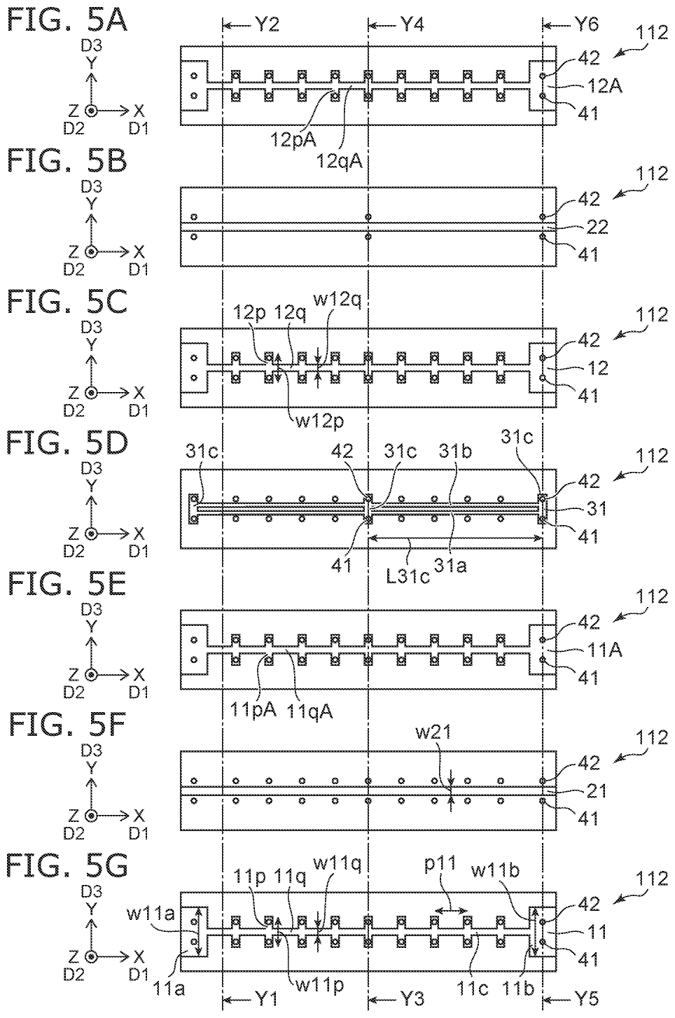

FIGS. 5A to 5G are schematic plan views illustrating a transmission line according to the first embodiment.

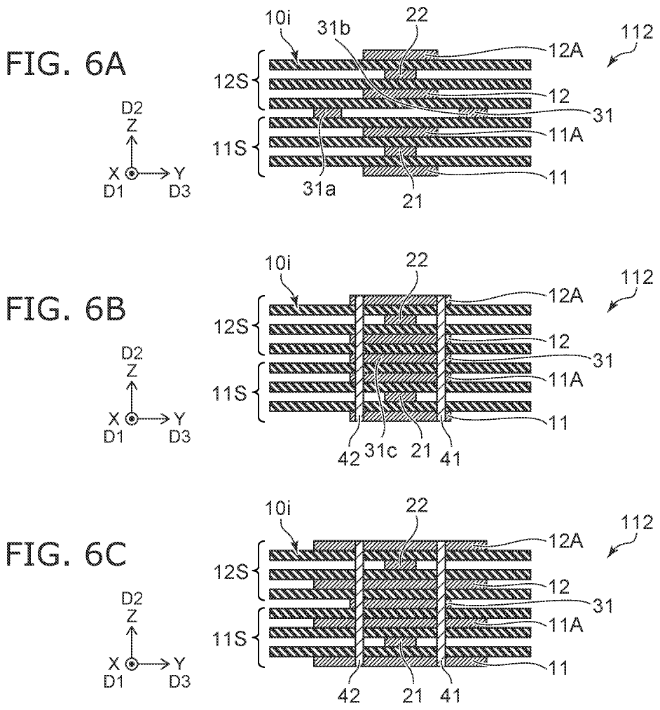

FIGS. 6A to 6C are schematic cross-sectional views illustrating the transmission line according to the first embodiment.

FIG. 6A is a cross-sectional view taken along the line Y1-Y2 in FIGS. 5A to 5G. FIG. 6B is a sectional view taken along the line Y3-Y4 in FIGS. 5A to 5G. FIG. 6C is a sectional view taken along the line Y5-Y6 in FIGS. 5A to 5G.

As shown in FIG. 5G, in a transmission line 112 according to the embodiment, the first conductive layer 11 includes a plurality of portions having different widths. The configuration of the transmission line 112 except for this may be the same as the configuration of the transmission line 111.

The first conductive layer 11 includes a plurality of first partial regions 11p and a plurality of first other partial regions 11q. One of the plurality of first partial regions 11p is located between one of the plurality of first other partial regions 11q and another one of the plurality of first other partial regions 11q in the first direction D1. One of the plurality of first other partial regions 11q is located between one of the plurality of first partial regions 11p and another one of the plurality of first partial regions 11p in the first direction D1. A length of one of the plurality of first partial regions 11p in the third direction D3 is defined as a first partial region length w11p. A length of one of the plurality of first other partial regions 11q in the third direction D3 is defined as a first other partial region length w11q. The first partial region length w11p is longer than the first other partial region length w11q.

A length (width) of the first conductive line 21 along the third direction D3 is defined as a length w21. In the embodiment, it is preferable that the first other partial region length w11q is equal to or longer than the length w21 of the first conductive line 21. Higher isolation characteristics can be obtained. For example, the first other partial region the length w11q may be not less than 1 time and not more than 3 times the length w21. If the first other partial region length w11q is excessively long, for example, heat conduction will increase.

For example, one of the plurality of first partial regions 11p being wide is provided between the plurality of first other partial regions 11q being narrow. In the plurality of first partial regions 11p being wide, the first conductive layer 11 may be electrically connected to other conductive layers.

As shown in FIG. 5A, FIG. 5C, and FIG. 5E, the pattern shapes of the second opposing conductive layer 12A, the second conductive layer 12, and the first opposing conductive layer 11A are substantially the same as the pattern shape of the first conductive layer 11.

For example, as shown in FIG. 5C, the second conductive layer 12 includes a plurality of second partial regions 12p and a plurality of second other partial regions 12q. One of the plurality of second partial regions 12p is located between one of the plurality of second other partial regions 12q and another one of the plurality of second other partial regions 12q in the first direction D1. One of the plurality of second other partial regions 12q is located between one of the plurality of second partial regions 12p and another one of the plurality of second partial regions 12p in the first direction D1. A length of one of the plurality of second partial regions 12p in the third direction D3 is defined as a second partial region length w12p. A length of one of the plurality of second other partial regions 12q in the third direction D3 is defined as a second other partial region length w12q. The second partial region length w12p is longer than the second other partial region length w12q. The second other partial region length w12q may be substantially the same as the first other partial region length w11q. For example, the second other partial region length w12q may be not less than 0.8 times and not more than 1.2 times the first other partial region length w11q.

As shown in FIG. 5E, for example, the first opposing conductive layer 11A includes a plurality of first opposing partial regions 11pA and a plurality of first opposing other partial regions 11qA. A length of one of the plurality of first opposing partial regions 11pA in the third direction D3 is longer than a length of one of the plurality of first opposing partial regions 11qA in the third direction.

As shown in FIG. 5A, for example, the second opposing conductive layer 12A includes a plurality of second opposing partial regions 12pA and a plurality of second opposing partial regions 12qA. A length of one of the plurality of second opposing partial regions 12pA in the third direction D3 is longer than a length of one of the plurality of second opposing partial regions 12qA in the third direction.

These conductive layers may be electrically connected to each other in the wide portions. For example, the first connecting member 41 and the second connecting member 42 are provided. These connecting members extend along the second direction D2.

The first connecting member 41 and the second connecting member 42 are electrically connected to one of the plurality of first partial regions 11p and one of the plurality of second partial regions 12p. The first connecting member 41 and the second connecting member 42 are electrically connected to one of the plurality of first opposing partial regions 11pA and one of the plurality of second opposing partial regions 12pA.

As shown in FIG. 6C, at least a part of the first intermediate conductive layer 31 is electrically connected to the first connecting member 41 and the second connecting member 42.

As shown in FIG. 5D, the first intermediate conductive layer 31 includes the plurality of connecting conductive layers 31c. The plurality of connecting conductive layers 31c are electrically connected to the first connecting member 41 and the second connecting member 42. The plurality of connecting conductive layers 31c connect a part of the first line 31a and a part of the second line 31b.

One of the plurality of connecting conductive layers 31c and another one of the plurality of connecting conductive layers 31c are electrically connected to the first connecting member 41 (and the second connecting member 42). The pitch between one of the plurality of connecting conductive layers 31c and another one of the plurality of connecting conductive layers 31c may be substantially ½ of the target wavelength. Isolation characteristics near the target wavelength are improved. Signals can be sent and received with higher efficiency.

For example, a distance in the first direction D1 between a position of a center of one of the plurality of connecting conductive layers 31c in the first direction D1 and a position of a center of other one of the plurality of connecting conductive layers 31c in the first direction D1 is defined as a distance L31c (see FIG. 5 (D). The distance L31c is preferably not less than 0.8 times and not more than 1.2 times of ½ of a wavelength of the signal passing through the first conductive line 21. The isolation characteristic near the target wavelength is improved. Signals can be transmitted and received with higher efficiency.

As shown in FIG. 5D, at least a part of the first intermediate conductive layer 31 may be provided between the first connecting member 41 and the second connecting member 42. For example, the first connecting member 41 and the second connecting member 42 are electrically connected to the first opposing conductive layer 11A and the second conductive layer 12. The first connecting member 41 and the second connecting member 42 are further electrically connected to the first conductive layer 11 and the second opposing conductive layer 12A.

In the embodiment, the first conductive line 21 and the second conductive line 22 are located between the first connecting member 41 and the second connecting member 42.

As shown in FIG. 5G, the first conductive layer 11 includes the first portion 11a and the first opposing portion 11b. The direction from the first portion 11a to the first opposing portion 11b is along the first direction D1. The plurality of first partial regions 11p and the plurality of first other partial regions 11q are located between the first portion 11a and the first opposing portion 11b. A length w11a of the first portion 11a along the third direction D3 is longer than the first other partial region length w11q.

As shown in FIG. 5G, for example, in the first conductive layer 11, the plurality of first partial regions 11p being wide may be arranged periodically in the first direction D1. A pitch p11 of the plurality of first partial regions 11p in the first direction D1 is preferably ¼ or less of the wavelength of the signal passing through the first conductive line 21. Thereby, a high shielding effect is obtained.

FIG. 7 is a graph illustrating characteristics of a transmission line.

The horizontal axis in FIG. 7 is the frequency f1. The vertical axis is the attenuation amount P1. The attenuation amount P1 corresponds to the amount by which a signal propagating through one of the plurality of signal lines propagates to another one of the plurality of signal lines. The attenuation amount P1 represents the amount of isolation between the two lines. For example, when the attenuation amount P1 is −30 dB, 1/1000 of the signal on one of the plurality of signal lines propagates to another one of the plurality of signal lines. When the level of the attenuation amount P1 is high, the signal on the other of the plurality of signal lines becomes noise for one of the plurality of signal lines. If the level of the attenuation amount P1 is high, the SN will deteriorate and the signal characteristics will deteriorate. FIG. 7 shows the characteristics of the transmission line 112 described above and the characteristics of a transmission line 119 of a reference example. In the transmission line 119 of the reference example, the first intermediate conductive layer 31 is not provided.

As shown in FIG. 7, in the transmission line 112, a large attenuation amount P1 is obtained in a wide band compared to the reference example. In the transmission line 112, the isolation characteristic can be improved by 15 dB or more with respect to the transmission line 119. For example, the influence of electromagnetic waves leaking from the transmission line (for example, the first conductive line 21) on other transmission lines (for example, the second conductive line 22) can be greatly reduced.

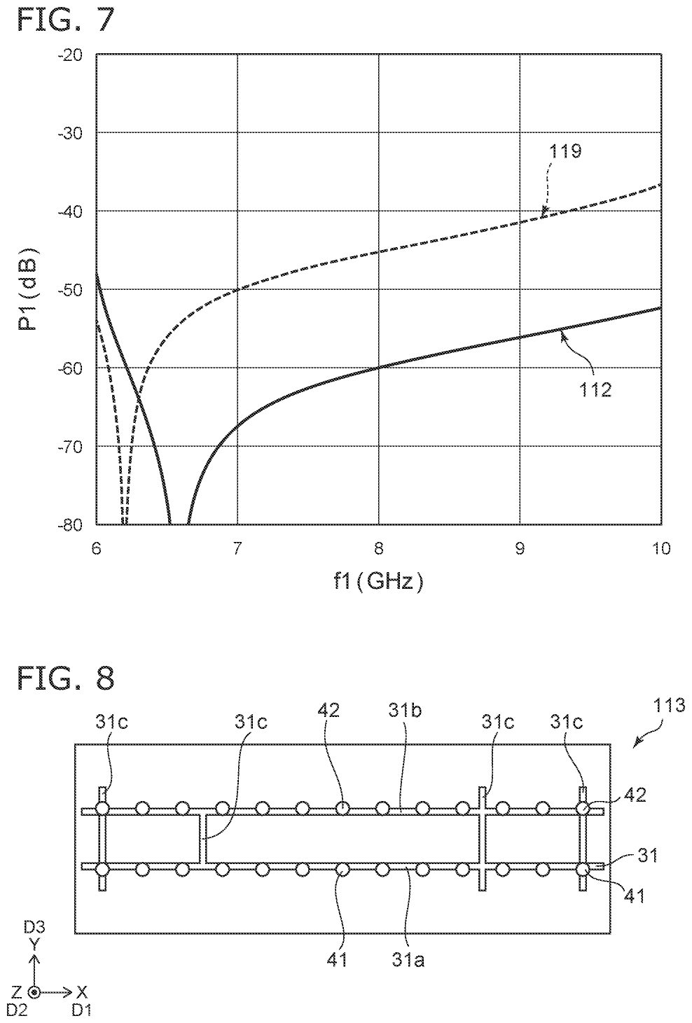

FIG. 8 is a schematic plan view illustrating a part of a transmission line according to the first embodiment.

FIG. 8 illustrates a pattern of the first intermediate conductive layer 31. As shown in FIG. 8, in a transmission line 113 according to the embodiment, the first line 31a contacts the first connecting member 41. The second line 31b contacts the second connecting member 42. The configuration of the transmission line 113 except for this may be the same as the configurations of the various transmission lines described above.

In this example, a length of at least one of the plurality of connecting conductive layers 31c along the third direction D3 is substantially the same as the distance between the first line 31a and the second line 31b. A length of another one of the plurality of connecting conductive layers 31c along the third direction D3 is longer than the distance between the first line 31a and the second line 31b. High isolation characteristics can also be obtained in the transmission line 113.

In the embodiment, the pattern shape of the first intermediate conductive layer 31 is preferably axisymmetric with respect to the first direction D1.

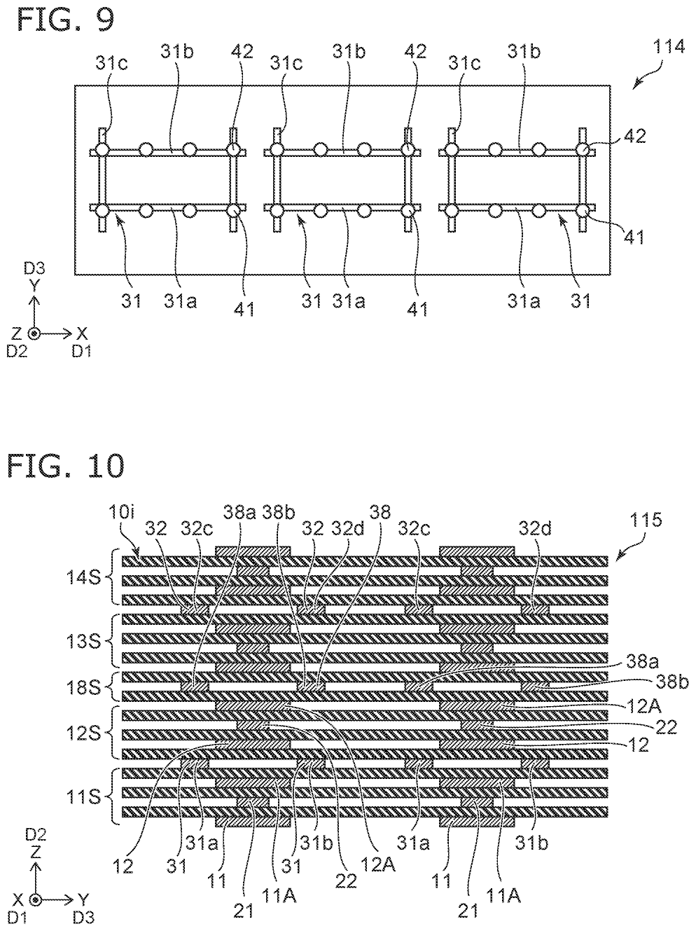

FIG. 9 is a schematic plan view illustrating a part of a transmission line according to the first embodiment.

FIG. 9 illustrates a pattern of the first intermediate conductive layer 31. As shown in FIG. 9, in a transmission line 114 according to the embodiment, a plurality of first intermediate conductive layers 31 are provided. The plurality of first intermediate conductive layers 31 are arranged along the first direction D1. The configuration of the transmission line 113 except for this may be the same as the configurations of the various transmission lines described above. High isolation characteristics can also be obtained in the transmission line 114.

In the transmission line 114, one of the plurality of first intermediate conductive layers 31 has an annular shape. A distance along the first direction D1 between one of the plurality of first intermediate conductive layers 31 and another one of the plurality of first intermediate conductive layers 31 is preferably ¼ or less the wavelength of the signal passing through the first conductive line 21. For example, a length of one of the plurality of first intermediate conductive layers 31 (for example, one of the plurality of first lines 31a) along the first direction D1 is ½ or less of the wavelength of the signal passing through the first conductive line 21.

FIG. 10 is a schematic cross-sectional view illustrating a transmission line according to the first embodiment.

As shown in FIG. 10, a transmission line 115 according to the embodiment includes a third structure 13S, a fourth structure 14S, and a second intermediate conductive layer 32. The configuration of the transmission line 115 except for this may be the same as the configurations of the various transmission lines described above.

The third structure 13S is provided between the second structure 12S and the fourth structure 14S. The second intermediate conductive layer 32 is provided between the third structure 13S and the fourth structure 14S. For example, the configuration of the third structure 13S may be similar to the configuration of the first structure 11S. For example, the configuration of the fourth structure 14S may be similar to the configuration of the second structure 12S. For example, the configuration of the second intermediate conductive layer 32 may be the same as the configuration of the first intermediate conductive layer 31. The second intermediate conductive layer 32 includes, for example, a third line 32c and a fourth line 32d. The third line 32c and the fourth line 32d extend along the first direction D1. High isolation characteristics can also be obtained in the transmission line 115.

In this example, the first structure 11S includes the plurality of first conductive layers 11, the plurality of first opposing conductive layers 11A, the plurality of second conductive layers 12, the plurality of second opposing conductive layers 12A, the plurality of first conductive lines 21, the plurality of second conductive lines 22, and the plurality of first intermediate conductive layers 31.

A direction from one of the plurality of first conductive layers 11 to another one of the plurality of first conductive layers 11 is along the third direction D3. A direction from one of the plurality of first opposing conductive layers 11A to another one of the plurality of first opposing conductive layers 11A is along the third direction D3. A direction from one of the plurality of second conductive layers 12 to another one of the plurality of second conductive layers 12 is along the third direction D3. A direction from one of the plurality of second opposing conductive layers 12A to another one of the plurality of second opposing conductive layers 12A is along the third direction D3. A direction from one of the plurality of first conductive lines 21 to another one of the plurality of first conductive lines 21 is along the third direction D3. A direction from one of the plurality of second conductive lines 22 to another one of the plurality of second conductive lines 22 is along the third direction D3. A direction from one of the plurality of first intermediate conductive layers 31 to another one of the plurality of first intermediate conductive layers 31 is along the third direction D3.

In this example, the transmission line 115 includes an interlayer structure 18S. The interlayer structure 18S is provided between the second structure 12S and the third structure 13S. The interlayer structure 18S includes an interlayer conductive layer 38. The interlayer conductive layer 38 includes a first interlayer line 38a extending along the first direction D1 and a second interlayer line 38b extending along the first direction D1. Higher isolation characteristics can be obtained. In this example, a plurality of first interlayer lines 38a and a plurality of second interlayer lines 38b are provided. a position of the first conductive line 21 in the third direction D3 is between a positions of the plurality of first interlayer lines 38a in one third direction D3 and a positions of the plurality of second interlayer lines 38b in one third direction D3.

The number of the plurality of conductive layers described above is arbitrary. The number of the plurality of conductive lines described above is arbitrary.

### Second Embodiment

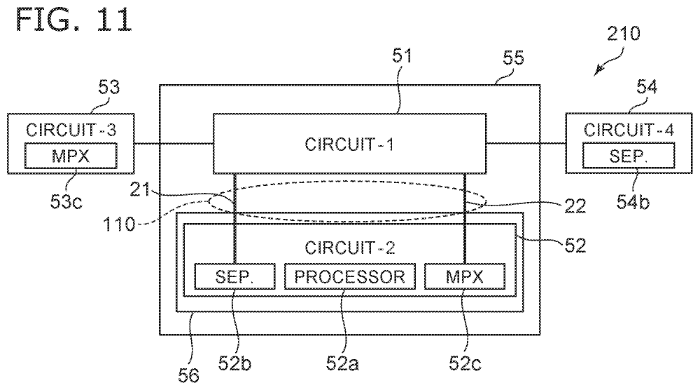

FIG. 11 is a schematic diagram illustrating a processing device according to the second embodiment.

As shown in FIG. 11, a processing device 210 according to the embodiment includes the transmission line (in this example, the transmission line 110) according to the first embodiment, a first signal processing circuit 51, and a second signal processing circuit 52. For example, one end of the first conductive line 21 is configured to be coupled with the first signal processing circuit 51. For example, another end of the first conductive line 21 is configured to be coupled with the second signal processing circuit 52. The signal processing circuits included in the processing device 210 is configured to be coupled with low loss. The coupling between the conductive line and the signal processing circuit may include a connection.

A first temperature of the first signal processing circuit 51 is different from a second temperature of the second signal processing circuit 52. By high thermal insulation of the transmission line 110, the temperature of these signal processing circuits are easily maintained at the desired state.

For example, the processing device 210 may be at least a part of a quantum computer. In the processing device 210, efficient cooling is possible even when lines for controlling a large number of quantum bits are provided, for example. For example, it is possible to provide a quantum computer that can operate with more bits than conventional ones. According to the embodiment, it is possible to provide a processing device (for example, a quantum computer) whose characteristics can be improved.

In this example, the processing device 210 may include a cooling device 55. The second signal processing circuit 52 is provided within the cooling device 55. The first signal processing circuit 51 may be provided within the cooling device 55. For example, the cooling device 55 includes a cooling section 56. The second signal processing circuit 52 is provided within the cooling section 56. The first signal processing circuit 51 is provided outside the cooling section 56. By the operation of the cooling section 56, the second temperature of the second signal processing circuit 52 becomes lower than the first temperature of the first signal processing circuit 51.

In this example, the second signal processing circuit 52 includes a signal separation section 52b, a processor 52a, and a signal multiplexing section 52c. For example, the first signal processing circuit 51 and the signal separation section 52b may be coupled by the first conductive line 21. The first signal processing circuit 51 and the signal multiplexing section 52c may be coupled by the second conductive line 22.

In this example, a third signal processing circuit 53 and a fourth signal processing circuit 54 are further provided. For example, the third signal processing circuit 53 includes a signal multiplexing section 53c. For example, the fourth signal processing circuit 54 includes a signal separation section 54b. The third signal processing circuit 53 is configured to be coupled with the first signal processing circuit 51. The fourth signal processing circuit 54 is configured to be coupled with the first signal processing circuit 51.

The embodiments may include the following Configurations (e.g., Technical proposals):

### (Configuration 1)

A transmission line, comprising:
a first structure including
   a first conductive layer,
   a first opposing conductive layer, and
   a first conductive line provided between the first conductive layer and the first opposing conductive layer, the first conductive line extending along a first direction, the first direction crossing a second direction from the first conductive layer to the first opposing conductive layer;
a second structure including
   a second conductive layer,
   a second opposing conductive layer, the first opposing conductive layer being provided between the first opposing conductive layer and the second opposing conductive layer, the second conductive layer being provided between the first opposing conductive layer and the second opposing conductive layer, and
   a second conductive line provided between the second conductive layer and the second opposing conductive layer, the second conductive line extending along the first direction; and
a first intermediate conductive layer provided between the first opposing conductive layer and the second conductive layer, the first intermediate conductive layer including a first line extending along the first direction and a second line extending along the first direction, a third direction from the first line to the second line crossing a plane including the first direction and the second direction.

### (Configuration 2)

The transmission line according to Configuration 1, wherein
in the third direction, a position of the first conductive line in the third direction is between a position of the first line in the third direction and a position of the second line in the third direction, and
in the third direction, a position of the second conductive line in the third direction is between the position of the first line in the third direction and the position of the second line in the third direction in the third direction.

### (Configuration 3)

The transmission line according to Configuration 2, further comprising:
a first connecting member extending along the second direction,
the first connecting member electrically connecting the first opposing conductive layer and the second conductive layer to each other.

### (Configuration 4)

The transmission line according to Configuration 3, further comprising:
a second connecting member extending along the second direction,
the second connecting member electrically connecting the first opposing conductive layer and the second conductive layer to each other, and
at least a part of the first intermediate conductive layer being provided between the first connecting member and the second connecting member.

### (Configuration 5)

The transmission line according to Configuration 4, wherein
the first connecting member and the second connecting member are electrically connected to the first conductive layer and the second opposing conductive layer.

### (Configuration 6)

The transmission line according to any one of Configurations 1-5, wherein
the first intermediate conductive layer further includes a connecting conductive layer connecting a part of the first line and a part of the second line.

### (Configuration 7)

The transmission line according to any one of Configurations 3-5, wherein
the first intermediate conductive layer includes a plurality of connecting conductive layers,
the plurality of connecting conductive layers connect a part of the first line and a part of the second line,
one of the plurality of connecting conductive layers and another one of the plurality of connecting conductive layers are electrically connected to the first connecting member, and
a distance in the first direction between a position of a center of the one of the plurality of connecting conductive layers in the first direction and a position of a center of another one of the plurality of connecting conductive layers in the first direction is not less than 0.8 times and not more than 1.2 times of ½ of a wavelength of a signal passing through the first conductive line.

### (Configuration 8)

The transmission line according to Configuration 2, wherein
the first conductive layer includes a plurality of first partial regions and a plurality of first other partial regions,
one of the plurality of first partial region is provided between one of the plurality of first other partial region and another one of the plurality of first other partial region in the first direction,
the one of the plurality of first other partial region is provided between the one of the plurality of first partial region and another one of the plurality of first partial region in the first direction, and
a first partial region length of the one of the plurality of first partial region in the first third direction is longer than a first other partial region length of the one of the plurality of first other partial region in the first third direction.

### (Configuration 9)

The transmission line according to Configuration 8, wherein
the first conductive layer further includes a first portion and a first opposing portion,
a direction from the first portion to the first opposing portion is along the first direction,
the plurality of first partial regions and the plurality of first other partial regions are provided between the first portion and the first opposing portion, and
a length of the first portion along the third direction is longer than a length of the first other partial region.

### (Configuration 10)

The transmission line according to Configuration 8 or 9, wherein
the first other partial region length is not less than 1 time and not more than 3 times a length of the first conductive line along the third direction.

### (Configuration 11)

The transmission line according to any one of Configurations 8-10, wherein
the second conductive layer includes a plurality of second partial regions and a plurality of second other partial regions,
one of the plurality of second partial regions is provided between one of the plurality of second other partial regions and another one of the plurality of second other partial regions in the first direction,
the one of the plurality of second other partial region is provided between the one of the plurality of second partial region and another one of the plurality of second partial region in the first direction,
a second partial region length of the one of the plurality of second partial region in the first third direction is longer than a second other partial region length of the one of the plurality of second other partial region in the first third direction, and
the second other partial region length is not less than 0.8 times and not more than 1.2 times the first other partial region length.

### (Configuration 12)

The transmission line according to Configuration 11, further comprising:
a first connecting member extending along the second direction; and
a second connecting member extending along the second direction,
the first connecting member and the second connecting member being electrically connected to the one of the plurality of first partial regions and the one of the plurality of second partial regions, and
at least a part of the first intermediate conductive layer being electrically connected to the first connecting member and the second connecting member.

### (Configuration 13)

The transmission line according to any one of Configurations 8-12, wherein
the plurality of first partial regions are arranged periodically in the first direction.

### (Configuration 14)

The transmission line according to Configuration 13, wherein
a pitch of the plurality of first partial regions in the first direction is equal to or less than ¼ of a wavelength of a signal passing through the first conductive line.

### (Configuration 15)

The transmission line according to Configuration 1, further comprising:
a first connecting member extending along the second direction; and
a second connecting member extending along the second direction,
the first connecting member and the second connecting member being electrically connected to the first opposing conductive layer and the second conductive layer, and
at least a part of the first intermediate conductive layer being between the first connecting member and the second connecting member.

### (Configuration 16)

The transmission line according to any one of Configurations 1-15, wherein
a plurality of the first intermediate conductive layers are provided, and
the plurality of first intermediate conductive layers are arranged along the first direction.

### (Configuration 17)

The transmission line according to any one of Configurations 1-16, wherein
the first intermediate conductive layer is electrically connected to the first conductive layer, the first opposing conductive layer, the second conductive layer, and the second opposing conductive layer.

### (Configuration 18)

The transmission line according to Configuration 9, wherein
a temperature of the first portion is different from a temperature of the first opposing portion.

### (Configuration 19)

A processing device, comprising:
the transmission line according to t any one of Configurations 1-18;
a first signal processing circuit; and
a second signal processing circuit,
one end of the first conductive line being configured to be coupled with the first signal processing circuit, and
another end of the first conductive line being configured to be coupled with the second signal processing circuit.

### (Configuration 20)

A processing device according to Configurations 19, wherein
a first temperature of the first signal processing circuit is different from a second temperature of the second signal processing circuit.

### (Configuration 21)

A quantum computer, comprising:
the transmission line according to any one of Configurations 1-18;
a first signal processing circuit; and
a second signal processing circuit, one end of the first conductive line being configured to be coupled with the first signal processing circuit, and
another end of the first conductive wire being configured to be coupled with the second signal processing circuit.

According to the embodiment, it is possible to provide a transmission line, a processing device, and a quantum computer whose characteristics can be improved.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the transmission lines, processing devices, and quantum computers such as conductive layers, conductive lines, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all transmission lines, all processing devices, and quantum computers practicable by an appropriate design modification by one skilled in the art based on the transmission lines, the processing devices, and quantum computers described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A transmission line, comprising:
a first structure including
a first conductive layer,
a first opposing conductive layer, and
a first conductive line provided between the first conductive layer and the first opposing conductive layer, the first conductive line extending along a first direction, the first direction crossing a second direction from the first conductive layer to the first opposing conductive layer;
a second structure including
a second conductive layer,
a second opposing conductive layer, the first opposing conductive layer being provided between the first opposing conductive layer and the second opposing conductive layer, the second conductive layer being provided between the first opposing conductive layer and the second opposing conductive layer, and
a second conductive line provided between the second conductive layer and the second opposing conductive layer, the second conductive line extending along the first direction; and
a first intermediate conductive layer provided between the first opposing conductive layer and the second conductive layer, the first intermediate conductive layer including a first line extending along the first direction and a second line extending along the first direction, a third direction from the first line to the second line crossing a plane including the first direction and the second direction.

2. The transmission line according to claim 1, wherein
in the third direction, a position of the first conductive line in the third direction is between a position of the first line in the third direction and a position of the second line in the third direction, and
in the third direction, a position of the second conductive line in the third direction is between the position of the first line in the third direction and the position of the second line in the third direction in the third direction.

3. The transmission line according to claim 2, further comprising:
a first connecting member extending along the second direction,
the first connecting member electrically connecting the first opposing conductive layer and the second conductive layer to each other.

4. The transmission line according to claim 3, further comprising:
a second connecting member extending along the second direction,
the second connecting member electrically connecting the first opposing conductive layer and the second conductive layer to each other, and
at least a part of the first intermediate conductive layer being provided between the first connecting member and the second connecting member.

5. The transmission line according to claim 4, wherein
the first connecting member and the second connecting member are electrically connected to the first conductive layer and the second opposing conductive layer.

6. The transmission line according to claim 1, wherein
the first intermediate conductive layer further includes a connecting conductive layer connecting a part of the first line and a part of the second line.

7. The transmission line according to claim 3, wherein
the first intermediate conductive layer includes a plurality of connecting conductive layers,
the plurality of connecting conductive layers connect a part of the first line and a part of the second line,
one of the plurality of connecting conductive layers and another one of the plurality of connecting conductive layers are electrically connected to the first connecting member, and
a distance in the first direction between a position of a center of the one of the plurality of connecting conductive layers in the first direction and a position of a center of another one of the plurality of connecting conductive layers in the first direction is not less than 0.8 times and not more than 1.2 times of ½ of a wavelength of a signal passing through the first conductive line.

8. The transmission line according to claim 2, wherein
the first conductive layer includes a plurality of first partial regions and a plurality of first other partial regions,
one of the plurality of first partial region is provided between one of the plurality of first other partial region and another one of the plurality of first other partial region in the first direction,
the one of the plurality of first other partial region is provided between the one of the plurality of first partial region and another one of the plurality of first partial region in the first direction, and
a first partial region length of the one of the plurality of first partial region in the first third direction is longer than a first other partial region length of the one of the plurality of first other partial region in the first third direction.

9. The transmission line according to claim 8, wherein
the first conductive layer further includes a first portion and a first opposing portion,
a direction from the first portion to the first opposing portion is along the first direction,
the plurality of first partial regions and the plurality of first other partial regions are provided between the first portion and the first opposing portion, and
a length of the first portion along the third direction is longer than a length of the first other partial region.

10. The transmission line according to claim 8, wherein
the first other partial region length is not less than 1 time and not more than 3 times a length of the first conductive line along the third direction.

11. The transmission line according to claim 8, wherein
the second conductive layer includes a plurality of second partial regions and a plurality of second other partial regions,
one of the plurality of second partial regions is provided between one of the plurality of second other partial regions and another one of the plurality of second other partial regions in the first direction,
the one of the plurality of second other partial region is provided between the one of the plurality of second partial region and another one of the plurality of second partial region in the first direction,
a second partial region length of the one of the plurality of second partial region in the first third direction is longer than a second other partial region length of the one of the plurality of second other partial region in the first third direction, and
the second other partial region length is not less than 0.8 times and not more than 1.2 times the first other partial region length.

12. The transmission line according to claim 11, further comprising:
a first connecting member extending along the second direction; and
a second connecting member extending along the second direction,
the first connecting member and the second connecting member being electrically connected to the one of the plurality of first partial regions and the one of the plurality of second partial regions, and
at least a part of the first intermediate conductive layer being electrically connected to the first connecting member and the second connecting member.

13. The transmission line according to claim 8, wherein
the plurality of first partial regions are arranged periodically in the first direction.

14. The transmission line according to claim 13, wherein
a pitch of the plurality of first partial regions in the first direction is equal to or less than ¼ of a wavelength of a signal passing through the first conductive line.

15. The transmission line according to claim 1, further comprising:
a first connecting member extending along the second direction; and
a second connecting member extending along the second direction,
the first connecting member and the second connecting member being electrically connected to the first opposing conductive layer and the second conductive layer, and
at least a part of the first intermediate conductive layer being between the first connecting member and the second connecting member.

16. The transmission line according to claim 1, wherein
a plurality of the first intermediate conductive layers are provided, and
the plurality of first intermediate conductive layers are arranged along the first direction.

17. The transmission line according to claim 1, wherein
the first intermediate conductive layer is electrically connected to the first conductive layer, the first opposing conductive layer, the second conductive layer, and the second opposing conductive layer.

18. The transmission line according to claim 9, wherein
a temperature of the first portion is different from a temperature of the first opposing portion.

19. A processing device, comprising:
the transmission line according to claim 1;
a first signal processing circuit; and
a second signal processing circuit,
one end of the first conductive line being configured to be coupled with the first signal processing circuit, and
another end of the first conductive line being configured to be coupled with the second signal processing circuit.

20. A quantum computer, comprising:
the transmission line according to claim 1;
a first signal processing circuit; and
a second signal processing circuit,
one end of the first conductive line being configured to be coupled with the first signal processing circuit, and
another end of the first conductive wire being configured to be coupled with the second signal processing circuit.
